(19) United States
(12) Patent Application Publication
(10) Pub. No.: US 2014/0077710 A1
(43) Pub. Date: Mar. 20, 2014

(54) LED LAMP STRUCTURE DRIVEN BY DOUBLE CURRENT AND DOUBLE CURRENT DRIVING METHOD THEREOF

(71) Applicant: HELIO OPTOELECTRONICS CORPORATION, Zhudong Town (TW)

(72) Inventors: Ming-Hung CHEN, Zhudong Town (TW); Ching-Jen PAN, Zhudong Town (TW)

(73) Assignee: Helio Optoelectronics Corporation, Zhudong Town (TW)

(21) Appl. No.: 13/671,216

(22) Filed: Nov. 7, 2012

(30) Foreign Application Priority Data
Sep. 14, 2012 (TW) 101133868

(51) Int. Cl. H05B 37/02

(52) U.S. Cl. 315/192; 315/297; 315/185 R

(57) ABSTRACT

Disclosed are an LED lamp structure driven by double current and a double current driving method thereof. The LED lamp structure driven by double current includes a COB package, a temperature sensor, and a controller. The COB package is provided therein with a blue LED chipset to be driven by a first current and a red LED chipset to be driven by a second current. The temperature sensor detects the working temperature of the red LED chipset, and the controller performs dynamic adjustment on the second current according to the working temperature so as to stabilize the color temperature of the LED lamp structure. Thus, as soon as the LED lamp structure is activated, its color temperature will be stabilized to ensure user comfort, which may otherwise be disturbed by variation of the color temperature.

### BACKGROUND OF THE INVENTION

1. Technical Field

The present invention relates to a light-emitting diode (LED) lamp structure and a driving method thereof. More particularly, the present invention relates to an LED lamp structure driven by double current and a double current driving method thereof.

2. Description of Related Art

With the development of LED technology, LEDs have gradually become major components in the lighting field. An LED lamp capable of emitting a cold white light, whose color temperature is higher than about 5300 K, brings about a feeling of brightness and is suitable for use in a workplace. An LED lamp capable of emitting a warm white light, whose color temperate is lower than 3300 K, gives rise to a feeling of warmth and relaxation and is perfect for use at home. Thus, a change in the color temperature has a direct impact on the user's feeling and comfort.

Generally speaking, the working temperature of an LED lamp starts to rise upon activation and will not be stable until some time later. However, it has been found that, in an LED lamp whose light is mixed from the light of a blue LED chip and a red LED chip, correlated color temperature (CCT) deviation tends to arise from a variation in the working temperature, and studies have shown that 90% of CCT instability is attributable to red LED chips. Hence, for the sake of user comfort, there is a need to search for a method and structure which can stabilize the color temperature of an LED lamp with a red LED chip immediately after the LED lamp is activated.

### BRIEF SUMMARY OF THE INVENTION

The present invention provides an LED lamp structure driven by double current and a double current driving method thereof. The LED lamp structure driven by double current includes a chip-on-board (COB) package, a temperature sensor, and a controller. By detecting the working temperature of the red LED chipset in the COB package, the driving current of the red LED chipset can be dynamically adjusted in real time to stabilize the color temperature of the LED lamp structure upon activation of the LED lamp structure. Now that variation of the color temperature is prevented, user comfort is ensured.

The present invention provides a light-emitting diode (LED) lamp structure driven by double current, comprising: a chip-on-board (COB) package provided therein with at least one blue LED chipset to be driven by a first current and at least one red LED chipset to be driven by a second current; a temperature sensor for detecting a working temperature of the at least one red LED chipset; and a controller electrically connected to the temperature sensor and configured for performing dynamic adjustment on the second current according to the working temperature so as to stabilize a color temperature of the LED lamp structure.

The present invention also provides a double current driving method of a light-emitting diode (LED) lamp structure, wherein the LED lamp structure comprises a chip-on-board (COB) package provided therein with at least one blue LED chipset and at least one red LED chipset, the double current driving method comprising the steps of: providing a constant current for driving the at least one blue LED chipset; measuring a working temperature, wherein a temperature of the at least one red LED chipset in operation is detected by a temperature sensor; and providing a dynamic current for driving the at least one red LED chipset, wherein the dynamic current is dynamically adjusted by a controller according to a variation of the working temperature so as to stabilize a color temperature of the LED lamp structure.

Implementation of the present invention at least produces the following advantageous effects:

1. Color temperature remains stable in the initial stage of activation.

2. Luminous flux remains stable in the initial stage of activation.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

FIG. 1 is a circuit block diagram of an LED lamp structure driven by double current according to an embodiment of the present invention;

FIG. 2 is the flowchart of a double current driving method of an LED lamp structure according to an embodiment of the present invention;

FIG. 3 is a plot showing the relationship between the working temperature and the correlated color temperature stability factor of an LED lamp structure when the double current driving method of the present invention is or is not applied to the LED lamp structure; and

FIG. 4 is a plot showing the relationship between the working temperature and normalized lumen depreciation of an LED lamp structure when the double current driving method of the present invention is or is not applied to the LED lamp structure.

### DETAILED DESCRIPTION OF THE INVENTION

### Embodiment of an LED Lamp Structure Driven by Double Current

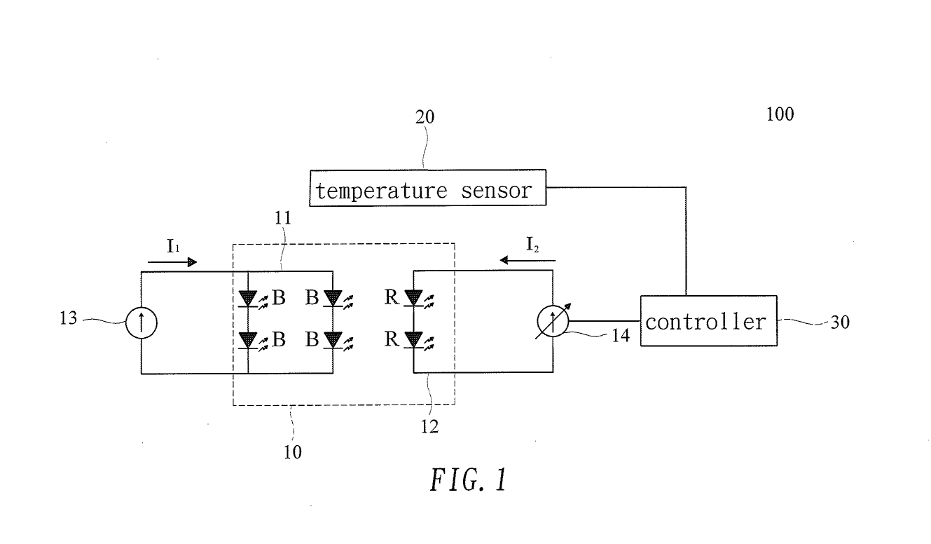

Referring to FIG. 1 for an embodiment of the present invention, an LED lamp structure 100 driven by double current includes a chip-on-board (COB) package 10, a temperature sensor 20, and a controller 30.

The COB package 10 is provided therein with at least one blue LED chipset 11 and at least one red LED chipset 12. The at least one blue LED chipset 11 and the at least one red LED chipset 12 may differ in number. For example, there may be two blue LED chipsets 11 and one red LED chipset 12, but the number of the at least one blue LED chipset 11 and of the at least one red LED chipset 12 is by no means limited to the foregoing.

The at least one blue LED chipset 11 and the at least one red LED chipset 12 in the COB package 10 are provided on a substrate or a circuit board and are electrically connected to the substrate or the circuit board by wires. Then, an encapsulation gel containing a phosphor powder is applied to and, thereby encapsulates the at least one blue LED chipset 11 and the at least one red LED chipset 12. When the COB package 10 is driven, the blue light emitted by the at least one blue LED chipset 11 excites the phosphor powder in the package and mixes with the red light emitted by the at least one red LED chipset 12 such that a white light is generated in the COB package 10.

The at least one blue LED chipset 11 is driven by a first current I₁, wherein each blue LED chipset 11 consists of a plurality of blue LED chips connected in series, in parallel, or in series and parallel. The first current I₁ is a constant current generated by a first current source 13. The intensity of the constant current is related to the chip properties and chip number of the at least one blue LED chipset 11 and how the chips are connected in series and/or parallel.

The at least one red LED chip 12 is driven by a second current I₂, which is generated by a second current source 14. Each red LED chipset 12 consists of a plurality of red LED chips connected in series, in parallel, or in series and parallel.

The temperature sensor 20 is configured for detecting the working temperature of the at least one red LED chipset 12, wherein the working temperature is the temperature around the at least one red LED chipset 12 during operation. The temperature sensor 20 is provided in the COB package 10 to directly measure the working temperature of the at least one red LED chipset 12 or, alternatively, is provided outside the COB package 10 to measure the working temperature of the at least on red LED chipset 12 only approximately. As a direct measurement or an approximate measurement of the working temperature of the at least one red LED chipset 12 makes little difference to the operation of the present invention, either approach may be used.

The controller 30 is electrically connected to the temperature sensor 20 and the second current source 14. The controller 30 may also be integrated with the temperature sensor 20 to form an integrated component, which is in turn electrically connected to the second current source 14. In a conventional LED lamp structure having a red LED chipset 12, variation of the color temperature of the LED lamp structure has much to do with the working temperature of the red LED chipset 12, which working temperature begins to vary upon activation and will not be stable until some time after the activation. As the color temperature of such a conventional LED lamp structure changes with the working temperature of the red LED chipset 12, it is impossible for the conventional LED lamp structure to reach the predetermined color temperature immediately after activation, and the user's feeling and comfort may be undesirably affected as a result.

In order for the working temperature of the at least one red LED chipset 12 to stabilize rapidly, the controller 30 in this embodiment of the present invention is configured for reading the temperature sensor 20's measurement of the working temperature of the at least one red LED chipset 12 and controlling the second current source 14 according to the working temperature read. Thus, the second current I₂ generated by the second current source 14 will be dynamically adjusted to stabilize the working temperature of the at least one red LED chipset 12 and thereby stabilize the color temperature of the LED lamp structure 100 driven by double current.

The aforesaid dynamic adjustment of the second current I₂ of the second current source 14 is performed by multiplying a base current by a compensation factor so as to obtain a compensated second current I₂ for driving the at least one red LED chipset 12. The intensity of the base current is independent of the first current I₁ and is related to the chip properties and chip number of the at least one red LED chipset 12 and how the chips are connected in series and/or parallel. The compensation factor can be looked up in a working temperature-compensation factor lookup table. Please refer to Table 1 for a working temperature-compensation factor lookup table for use in the present embodiment. When the working temperature is 20° C., 30° C., 40° C., 50° C., 60° C., 70° C., 80° C., or 90° C., the corresponding compensation factor is 0.8, 0.85, 0.9, 0.95, 1, 1.05, 1.15, or 1.25 respectively.

TABLE 1

| | Working temperature | | | | | | | |
|---|---|---|---|---|---|---|---|---|
| | 20° C. | 30° C. | 40° C. | 50° C. | 60° C. | 70° C. | 80° C. | 90° C. |
| Compensation factor | 0.8 | 0.85 | 0.9 | 0.95 | 1 | 1.05 | 1.15 | 1.25 |

For example, if the working temperature of the at least one red LED chipset 12 upon activation is 30° C. as measured by the temperature sensor 20, the controller 30 will multiply the base current by the compensation factor 0.85 in order to obtain the second current I₂ for driving the at least one red LED chipset 12. When the working temperature rises to 35° C., which involves only a small increase in the working temperature, the same compensation factor (i.e., 0.85) may still be applied, or the compensation factor corresponding to 40° C. may be used. When the working temperature rises to 40° C., the base current must be multiplied by the compensation factor 0.9 in order to obtain the second current I₂ for driving the at least one red LED chipset 12. Thus, by adjusting the second current I₂ through compensation, the color temperature of the LED lamp structure is stabilized.

### Embodiment of a Double Current Driving Method of an LED Lamp Structure

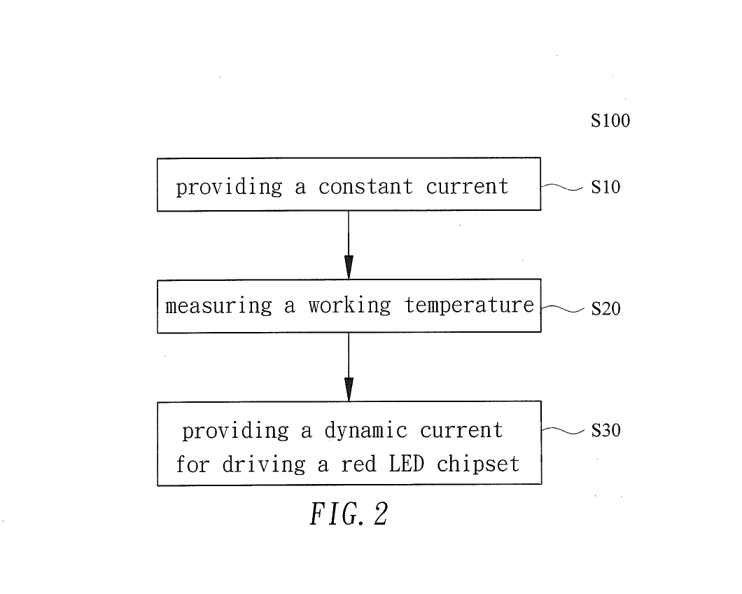

According to another embodiment of the present invention as shown in FIG. 2, a double current driving method S100 of an LED lamp structure includes the steps of: providing a constant current (step S10), measuring a working temperature (step S20), and providing a dynamic current for driving a red LED chipset (step S30). The LED lamp structure includes a COB package 10, and the COB package 10 is provided therein with at least one blue LED chipset 11 and at least one red LED chipset 12.

In the step of providing a constant current (step S10), a constant current I₁ for driving the at least one blue LED chipset 11 is generated by a first current source 13. The intensity of the constant current I₁ is related to the chip properties and chip number of the at least one blue LED chipset 11 and how the chips are connected in series and/or parallel.

The step of measuring a working temperature (step S20) entails detecting the working temperature of the at least one red LED chipset 12 by a temperature sensor 20, wherein the working temperature is the temperature around the at least one red LED chipset 12 during operation. The temperature sensor 20 is provided in the COB package 10 to directly measure the working temperature of the at least one red LED chipset 12 or is provided outside the COB package 10 to measure the working temperature of the at least one red LED chipset 12 only approximately. As a direct measurement or an approximate measurement of the working temperature of the at least one red LED chipset 12 makes little difference to the operation of the present invention, either approach may be used.

The step of providing a dynamic current for driving a red LED chipset (step S30) is carried out in the following manner. In the initial stage of activation, the at least one red LED chipset 12 is driven by a base current, whose intensity is related to the chip properties and chip number of the at least one red LED chipset 12 and how the chips are connected in series and/or parallel. When there is a change in the working temperature read by a controller 30, the controller 30 adjusts the second current source 14 dynamically according to the change in the working temperature detected by the temperature sensor 20, so as to produce a dynamic current I₂ for driving the at least one red LED chipset 12. Thus, the color temperature of the LED lamp structure is stabilized. The dynamic current I₂ is the product of the base current of the at least one red LED chipset 12 and a compensation factor. The compensation factor can be obtained from a working temperature-compensation factor lookup table as shown in Table 1. According to Table 1, the compensation factor is 0.8, 0.85, 0.9, 0.95, 1, 1.05, 1.15, or 1.25 when the working temperature is 20° C., 30° C., 40° C., 50° C., 60° C., 70° C., 80° C., or 90° C. respectively.

For example, if the working temperature of the at least one red LED chipset 12 upon activation is 30° C. as measured by the temperature sensor 20, the controller 30 will instruct the second current source 14 to perform dynamic adjustment. The dynamic adjustment is performed by multiplying the base current by the compensation factor 0.85, so as to obtain the dynamic current I₂ for driving the at least one red LED chipset 12. When the working temperature rises to 35° C., which involves only a small increase in the working temperature, the same compensation factor (i.e., 0.85) may still be applied, or the compensation factor corresponding to 40° C. may be used. When the working temperature rises to 40° C., the base current must be multiplied by the compensation factor 0.9 in order to obtain the dynamic current I₂ for driving the at least one red LED chipset 12. Thus, by adjusting the dynamic current I₂ through compensation, the color temperature of the LED lamp structure is stabilized.

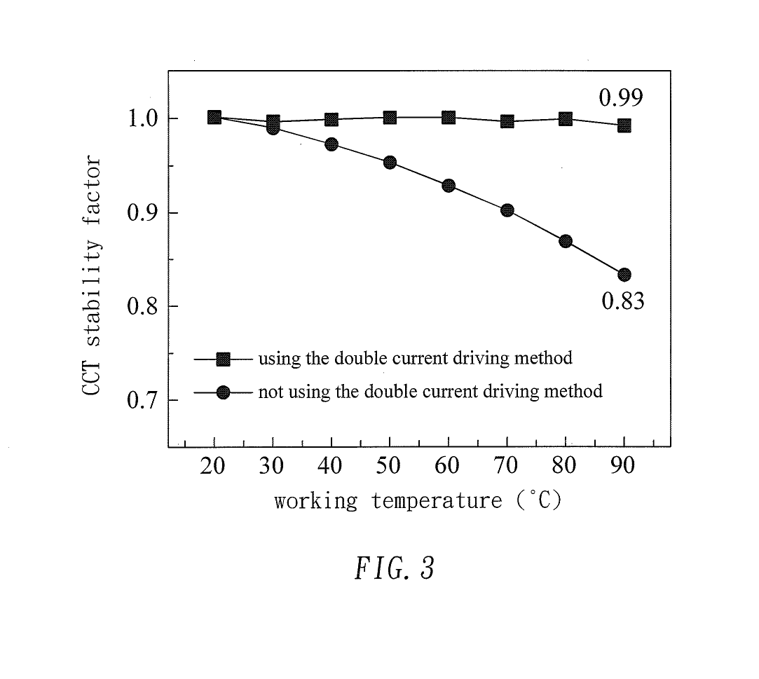

FIG. 3 shows a comparison between an LED lamp structure using the double current driving method S100 and an LED lamp structure not using the double current driving method S100. In the LED lamp structure using the double current driving method S100, the correlated color temperature (CCT) stability factor shows relatively little variation with the working temperature and remains at 0.99 when the working temperature is 90° C. By contrast, the CCT stability factor of the LED lamp structure not using the double current driving method S100 plummets to 0.83 when the working temperature is 90° C. The CCT stability factor is calculated by dividing the difference between an original CCT and a CCT deviation by the original CCT, i.e., CCT stability factor=(original CCT−CCT deviation)/original CCT. The higher the CCT stability factor is, the more stable the color temperature of an LED lamp structure will be. It can be known from the above that the LED lamp structure using the double current driving method S100 is indeed capable of significantly reducing variation of its color temperature as the working temperature changes.

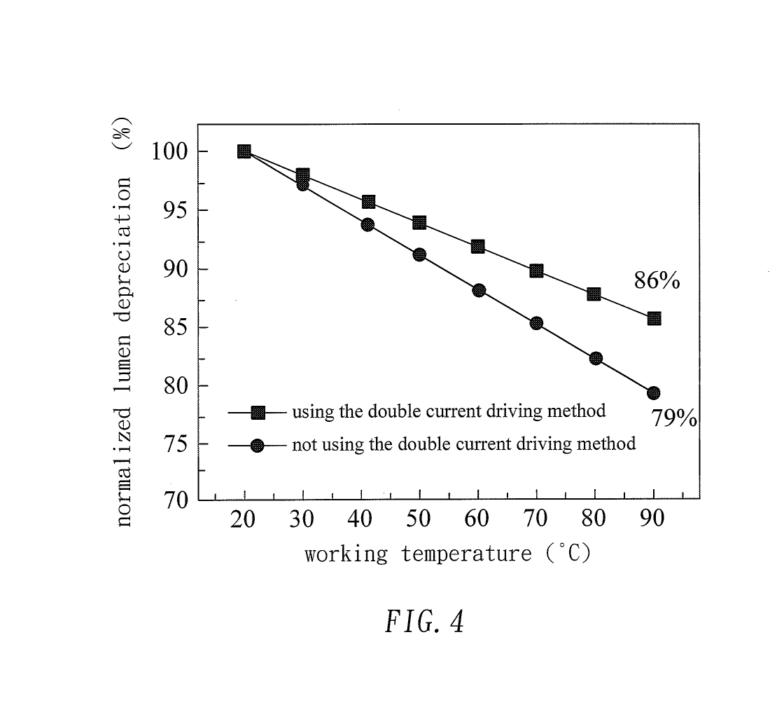

FIG. 4 shows another comparison between an LED lamp structure using the double current driving method S100 and an LED lamp structure not using the double current driving method S100. In the LED lamp structure using the double current driving method S100, normalized lumen depreciation is as low as 14% when the working temperature reaches 90° C. By contrast, normalized lumen depreciation of the LED lamp structure not using the double current driving method S100 is 21% when the working temperature is 90° C. It can be known from the above that the LED lamp structure using the double current driving method S100 shows relatively less depreciation in luminous flux when the working temperature increases. In other words, the LED lamp structure using the double current driving method S100 can maintain a good luminous flux despite a rising working temperature.

According to the foregoing, both the disclosed LED lamp structure driven by double current and the double current driving method thereof can reduce color temperature deviation and a lowering of luminous flux as the working temperature varies. This allows the color temperature and the luminous flux of the LED lamp structure to stabilize immediately after the LED lamp structure is activated.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A light-emitting diode (LED) lamp structure driven by double current, comprising:
a chip-on-board (COB) package provided therein with at least one blue LED chipset to be driven by a first current and at least one red LED chipset to be driven by a second current;
a temperature sensor for detecting a working temperature of the at least one red LED chipset; and
a controller electrically connected to the temperature sensor and configured for performing dynamic adjustment on the second current according to the working temperature so as to stabilize a color temperature of the LED lamp structure.

2. The LED lamp structure of claim 1, wherein each said blue LED chipset consists of a plurality of blue LED chips connected in series, in parallel, or in series and parallel.

3. The LED lamp structure of claim 1, wherein each said red LED chipset consists of a plurality of red LED chips connected in series, in parallel, or in series and parallel.

4. The LED lamp structure of claim 1, wherein the first current is a constant current.

5. The LED lamp structure of claim 1, wherein the dynamic adjustment on the second current is performed by multiplying a base current by a compensation factor, and the compensation factor can be looked up in a working temperature-compensation, factor lookup table.

6. The LED lamp structure of claim 5, wherein the working temperature-compensation factor lookup table reads that the compensation factor is 0.8, 0.85, 0.9, 0.95, 1, 1.05, 1.15, or 1.25 when the working temperature is 20° C., 30° C., 40° C., 50° C., 60° C., 70° C., 80° C., or 90° C. respectively.

7. A double current driving method of a light-emitting diode (LED) lamp structure, wherein the LED lamp structure comprises a chip-on-board (COB) package provided therein with at least one blue LED chipset and at least one red LED chipset, the double current driving method comprising the steps of:
providing a constant current for driving the at least one blue LED chipset;
measuring a working temperature, wherein a temperature of the at least one red LED chipset in operation is detected by a temperature sensor; and
providing a dynamic current for driving the at least one red LED chipset, wherein the dynamic current is dynamically adjusted by a controller according to a variation of the working temperature so as to stabilize a color temperature of the LED lamp structure.

8. The double current driving method of claim 7, wherein the dynamic current is a product of a base current and a compensation factor, and the compensation factor can be looked up in a working temperature-compensation factor lookup table.

9. The double current driving method of claim 8, wherein the working temperature-compensation factor lookup table reads that the compensation factor is 0.8, 0.85, 0.9, 0.95, 1, 1.05, 1.15, or 1.25 when the working temperature is 20° C., 30° C., 40° C., 50° C., 60° C., 70° C., 80° C., or 90° C. respectively.
